(19) United States
(12) Patent Application Publication
(10) Pub. No.: US 2019/0143387 A1
(43) Pub. Date: May 16, 2019

(54) SHEET METAL TUBE AND METHOD OF MANUFACTURING SAME

(71) Applicant: CUMMINS EMISSION SOLUTIONS INC., Columbus, IN (US)

(72) Inventors: Neha Verma, Pune (IN); Snehal Shivaji Yesumali, Pune (IN)

(73) Assignee: CUMMINS EMISSION SOLUTIONS INC., Columbus, IN (US)

(21) Appl. No.: 15/810,307

(22) Filed: Nov. 13, 2017

(51) Int. Cl. B21D 5/10; F01N 3/20; F01N 3/28

(52) U.S. Cl. CPC B21D 5/10; F01N 3/2066; B01D 53/9495; F01N 3/2073; F01N 3/2882

(57) ABSTRACT

A method includes providing first and second half-pipe sections. Each of the first and second half-pipe sections includes a first curved portion and defines a first outer edge length. Third and fourth half-pipe sections are provided. Each of the third and fourth half-pipe sections includes a second curved portion and defines a second outer edge length. The second outer edge length is longer than the first outer edge length. The first half-pipe section is welded to the third half-pipe section so as to form a first half-pipe subassembly. The second half-pipe section is welded to the fourth half-pipe section so as to form a second half-pipe subassembly. The first half-pipe subassembly is welded to the second half-pipe subassembly so as to form an exhaust tube section.

### TECHNICAL FIELD

The present disclosure relates generally to exhaust systems.

### BACKGROUND

Exhaust systems include an exhaust manifold, one or more exhaust aftertreatment devices, and pipes connecting these components. In some arrangements, the pipes include bends to route the exhaust gas along a non-linear path.

### SUMMARY

One embodiment relates to a method that includes providing first and second half-pipe sections. Each of the first and second half-pipe sections includes a first curved portion and defines a first outer edge length. Third and fourth half-pipe sections are provided. Each of the third and fourth half-pipe sections includes a second curved portion and defines a second outer edge length. The second outer edge length is longer than the first outer edge length. The first half-pipe section is welded to the third half-pipe section so as to form a first half-pipe subassembly. The second half-pipe section is welded to the fourth half-pipe section so as to form a second half-pipe subassembly. The first half-pipe subassembly is welded to the second half-pipe subassembly so as to form an exhaust tube section.

Another embodiment relates to an exhaust tube section. The exhaust tube section includes first, second, third, and fourth half-pipe sections. The first and third half-pipe sections are welded to one another, forming a first half-pipe subassembly. The second and fourth half-pipe sections are welded to one another, forming a second half-pipe subassembly. Each of the first and second half-pipe sections includes a first curved portion and has a first outer edge length. Each of the third and fourth half-pipe sections includes a second curved portion and has a second outer edge length. The second outer edge length is longer than the first outer edge length.

Another embodiment relates to a system. The system includes an exhaust assembly, which includes a first straight portion structured to be fluidly coupled to an engine. The exhaust assembly also includes a second straight portion structured to be fluidly coupled to an exhaust aftertreatment component. A bend portion is fluidly coupled to each of the first and second straight portions. The bend portion includes first, second, third, and fourth half-pipe sections. A first half-pipe subassembly includes the first and third half-pipe sections welded to one another. A second half-pipe subassembly is welded to the first half-pipe subassembly. The second half-pipe subassembly includes the second and fourth half-pipe sections welded to one another. Each of the first and second half-pipe sections includes a first curved portion and has a first outer edge length. Each of the third and fourth half-pipe sections includes a second curved portion and has a second outer edge length. The second outer edge length is longer than the first outer edge length.

These and other features, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims.

FIG. 1 is a plan view of an exhaust assembly, according to an embodiment.

FIG. 2 is a perspective view of an exhaust tube section, according to an embodiment.

FIG. 3 is a perspective view of the first half-pipe section of the exhaust tube section of FIG. 2.

FIG. 4 is a perspective view of the third half-pipe section of the exhaust tube section of FIG. 2.

FIG. 5 is a detailed view of the first half-pipe section of FIGS. 2 and 3 being positioned for assembly with the third half-pipe section of FIGS. 2 and 4.

FIG. 6 is a perspective view of a first half-pipe subassembly including the first half-pipe section of FIGS. 2, 3, and 5, and the third half-pipe section of FIGS. 2, 4, and 5.

FIG. 7 is an exploded perspective view of the first half-pipe subassembly and a second half-pipe subassembly.

FIG. 8 is a flow chart illustrating a method of manufacturing an exhaust tube section, according to an embodiment.

FIGS. 9A and 9B are exploded perspective views of a pipe section including two one-piece half-pipes, according to an alternative embodiment.

It will be recognized that some or all of the figures are schematic representations for purposes of illustration. The figures are provided for the purpose of illustrating one or more implementations with the explicit understanding that they will not be used to limit the scope or the meaning of the claims.

### DETAILED DESCRIPTION

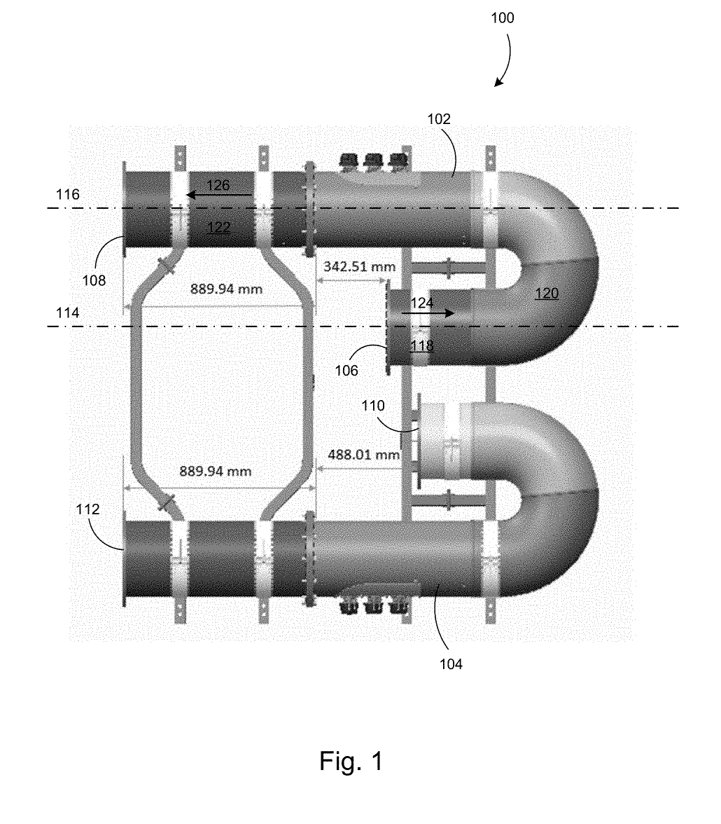

FIG. 1 is a plan view of an exhaust assembly 100, according to an embodiment. The exhaust assembly 100 is a portion of an exhaust system structured to receive exhaust gas from an engine, treat the exhaust gas so as to remove harmful constituents therefrom, and to expel the treated exhaust gas to an external environment. The exhaust assembly 100 of FIG. 1 is structured to cause exhaust gas flowing therethrough to change direction by about 180 degrees. As will be appreciated, the exhaust assembly 100 includes a 180 degree bend to change the flow direction of the exhaust gas flowing therethrough. In some implementations, the exhaust assembly 100 including the 180 degree bend may be used in a vehicle or genset with a relatively small space claim for the exhaust system. The 180 degree bend enables the use of additional exhaust aftertreatment devices, such as a decomposition reactor and a selective catalytic reduction (“SCR”) catalyst, in a vehicle or genset with limited available space. In some implementations, the 180 degree bend may also promote laminar flow of exhaust gas flowing therethrough.

The exhaust assembly 100 includes a first pipe section 102 and a second pipe section 104. The first pipe section 102 extends between a first inlet 106 and a first outlet 108. The second pipe section 104 extends between a second inlet 110 and a second outlet 112. The first and second inlets 106, 110 are structured to be fluidly coupled to an engine (not shown) so as to be in exhaust gas receiving communication with the engine. The first and second outlets 108, 112 are structured to be fluidly coupled to an exhaust aftertreatment component so as to be in exhaust gas providing communication to the exhaust aftertreatment component. For example, in one embodiment, the first and second outlets 108, 112 are structured to be fluidly coupled to a decomposition reactor.

As illustrated in FIG. 1, the first and second pipe sections 102, 104 are substantially “U-shaped” so that the exhaust gas entering the first and second pipe sections 102, 104 via the respective first and second inlets 106, 110 is redirected at an angle of about 180 degrees to the respective first and second outlets 108, 112. More specifically, the first inlet 106 of the first pipe section 102, for example, defines a first central axis 114. The first outlet 108 of the first pipe section 102 defines a second central axis 116. In one embodiment, as shown in FIG. 1, the first and second central axes 114, 116 are parallel.

According to various embodiments, the first and second pipe sections 102, 104 each comprise a plurality of components that are assembled to form the first and second pipe sections 102, 104. For example, the first pipe section 102 comprises a first straight portion 118, a bend portion 120, and a second straight portion 122. The bend portion 120 is fluidly coupled to each of the first and second straight portions 118, 122. As will be appreciated, each of the first straight portion 118, the bend portion 120, and the second straight portion 122 may be formed from a plurality of sub-components. In some embodiments, the first straight portion 118, the bend portion 120, and the second straight portion 122 are formed from sheet metal, such as steel or aluminum.

In operation, exhaust gas flows into the first inlet 106 and through a first straight portion 118 along a first flow direction 124, which is substantially parallel to the first central axis 114. The exhaust gas flows from the first straight portion 118 into the bend portion 120. The exhaust gas then flows from the bend portion 120 into the second straight portion 122 along a second flow direction 126, which is substantially parallel to the second central axis 116. The first and second flow directions 124, 126 are opposite each other. In other words, the first and second flow directions 124, 126 are oriented about 180 degrees from each other. The bend portion 120 is generally “U-shaped” so as to reverse a flow direction of the exhaust gas flowing therethrough from the first flow direction 124 to the second flow direction 126.

There are several manufacturing challenges associated with constructing the bend portion 120. One method of manufacturing the bend portion 120 is to bend a single pipe using a mandrel. One side effect of bending a pipe is that the wall thickness changes. In particular, the wall along the inner radius becomes thicker and the wall along the outer radius becomes thinner. These effects are typically more problematic the smaller the radius (the tighter the bend) and the larger the cross-sectional diameter of the pipe. The exhaust assembly 100 illustrated in FIG. 1 is utilized with relatively large heavy-duty diesel or natural gas engines. In one embodiment, the exhaust assembly 100 is constructed of 14 inch diameter sheet metal tubing. In such embodiments, the relatively large diameter of the tubing and the relatively small radius of the bend portion 120 prohibit the exhaust assembly 100 from being formed by bending a single pipe. Pipe bending is typically used to bend pipes at relatively small angles, such as 90 degrees or less. Therefore, pipe bending is not a suitable method of manufacturing the bend portion 120.

Another method of manufacturing the bend portion 120 is to weld together several half-pipe sections. For example, in some conventional systems, the bend portion 120 is manufactured by welding together four half-pipe sections. In some conventional systems, each of the four half-pipe sections is a unique part, which increases the total unique part count of the system. This increases the complexity and cost of bill of materials (“BOM”) and part order management. In addition, poka-yoke (mistake-proofing) becomes more difficult with more unique parts.

Various embodiments relate to a sheet metal tube with a 180 degree bend, and a method of manufacturing the same. According to an embodiment, four half-pipe sections are provided. The four half-pipe sections comprise two unique parts. For example, first and second half-pipe sections have a first shape and third and fourth half-pipe sections have a second shape different than the first shape. The first and third half-pipe sections are welded together so as to form a first half-pipe subassembly, and the second and fourth half-pipe sections are welded together so as to form a second half-pipe subassembly. The first and second half-pipe assemblies are welded together so as to form an exhaust tube section with a 180 degree bend.

In some embodiments, the first and third half-pipe sections (and therefore also the second and fourth half pipe sections) are shaped so that a weld seam is off-center relative to a radius of the bend portion. For example, in some embodiments, each of the first and second half-pipe sections have a first outer edge length, and each of the third and fourth half-pipe sections have a second outer edge length that is longer than the first outer edge length. When the two half-pipe subassemblies are positioned to be welded, one of the half-pipe subassemblies is flipped relative to the other half-pipe subassembly. Therefore, the weld seams of each of the first and second half-pipe assemblies are not aligned, but are rather offset from each other. In operation, offsetting the weld seams minimizes heat concentrations formed at the weld seams.

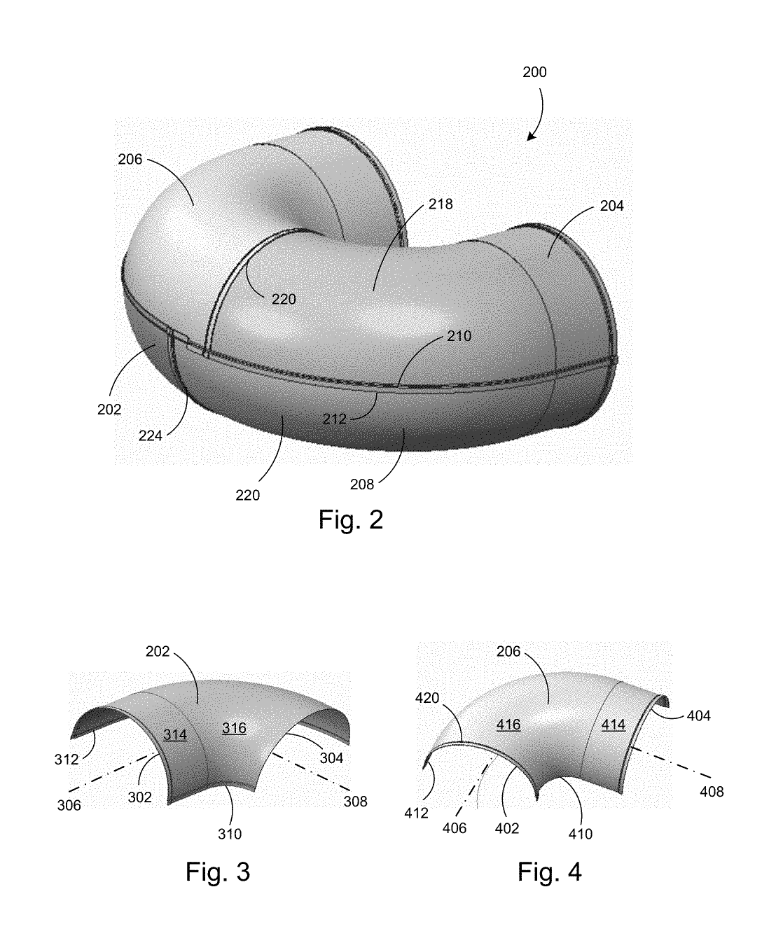

FIG. 2 is a perspective view of an exhaust tube section 200, according to an embodiment. The exhaust tube section 200 includes a 180 degree bend. In an embodiment, the exhaust tube section 200 corresponds to the bend portion 120 of the exhaust assembly 100 of FIG. 1. In other embodiments, the exhaust tube section 200 is not utilized in an exhaust system, but is rather utilized in a different application, such as an HVAC system.

The exhaust tube section 200 comprises first, second, third, and fourth half-pipe sections 202, 204, 206, 208 that are welded together to form the exhaust tube section 200. The first and second half-pipe sections 202, 204 each have a first shape and the third and fourth half-pipe sections 206, 208 have a different second shape. Accordingly, the first and second half-pipe sections 202, 204 comprise a first unique part in a BOM of the exhaust tube section 200, and the third and fourth half-pipe sections 206, 208 comprise a second unique part in the BOM. As described in further detail in connection with FIGS. 3 and 4, the first and second half-pipe sections 202, 204 have a first outer edge length 210, and the third and fourth half-pipe sections 206, 208 have a second outer edge length 212 that is longer than the first outer edge length 210.

The first and third half-pipe sections 202, 206 are welded together to form a first half-pipe subassembly 218 having a first weld seam 220. The second and fourth half-pipe sections 204, 208 are welded together to form a second half-pipe subassembly 222 having a second weld seam 224. The first and second half-pipe subassemblies 218, 222 are welded together to form the exhaust tube section 200. As illustrated in FIG. 2, the first and second weld seams 220, 224 are not aligned in the exhaust tube section 200. The first half-pipe subassembly 222 defines a third outer edge length and the second half-pipe assembly defines a fourth outer edge length. In some embodiments, the third and fourth outer edge lengths are the same. For example, the third and fourth outer edge lengths may be the same in embodiments that include the same amount of overlap between the first and third half-pipe sections 202, 206, and the second and fourth half-pipe sections 204, 208, respectively. In other embodiments, the third and fourth outer edge lengths are different. For example, the third and fourth outer edge lengths may be different in embodiments that include different amounts of overlap between the first and third half-pipe sections 202, 206, and the second and fourth half-pipe sections 204, 208, respectively.

FIG. 3 is a perspective view of the first half-pipe section 202 of FIG. 2. The first half-pipe section 202 has a substantially “D-shaped,” or semispherical, cross-section extending between a first inlet 302 and a first outlet 304. It should be appreciated that the terms “inlet” and “outlet,” as used herein, are not intended to define a flow direction in all instances. The exhaust tube section 200, as illustrated in FIG. 2, is symmetric. Accordingly, the exhaust tube section 200 may be oriented such that exhaust gas flows into an opening defined by the first and third half-pipe sections 202, 206 and out of an opening defined by the second and fourth half-pipe sections 204, 208. Along the same vein, the exhaust tube section 200 may be oriented such that exhaust gas flows into an opening defined by the second and fourth half-pipe sections 204, 208 and out of an opening defined by the first and third half-pipe sections 202, 206. It should be appreciated that the second half-pipe section 204 has the same shape as the first half-pipe section 202. However, because the first and second half-pipe sections 202, 204 are positioned opposite each other in the exhaust tube section 200, the first inlet 302 of the first half-pipe section 202 corresponds to an outlet of the second half-pipe section 204, and the first outlet 304 of the first half-pipe section 202 corresponds to an inlet of the second half-pipe section 204.

The first inlet 302 defines a first central axis 306 of the first half-pipe section 202. The first inlet 302 has a constant radius relative to the first central axis 306. The first central axis 306 is perpendicular to a plane defined by the first inlet 302. Similarly, the first outlet 304 defines a second central axis 308 of the first half-pipe section 202. The first outlet 304 has a constant radius relative to the second central axis 308. The second central axis 308 is perpendicular to a plane defined by the first outlet 304. According to various embodiments, the first and second central axes 306, 308 are not parallel. In some embodiments, the first and second central axes 306, 308 are perpendicular.

The first half-pipe section 202 has a first inner edge 310 and a first outer edge 312. The first inner edge 310 defines a first inner edge length extending between the first inlet 302 and the first outlet 304. Similarly, the first outer edge 312 defines a first outer edge length extending between the first inlet 302 and the first outlet 304. The first half-pipe section 202 includes a first straight portion 314 and a first curved portion 316. The first curved portion 316 defines a 90 degree bend, which is structured to change a flow direction of exhaust gas flowing therethrough by 90 degrees. As illustrated in FIG. 3, the first straight portion 314 defines the first inlet 302 and the first curved portion 316 defines the first outlet 304.

FIG. 4 is a perspective view of the third half-pipe section 206 of FIG. 2. The third half-pipe section 206 has a substantially “D-shaped,” or semispherical, cross-section extending between a second inlet 402 and a second outlet 404. The second inlet 402 defines a third central axis 406 of the third half-pipe section 206. The second inlet 402 has a constant radius relative to the third central axis 406. The third central axis 406 is perpendicular to a plane defined by the second inlet 402. Similarly, the second outlet 404 defines a fourth central axis 408 of the third half-pipe section 206. The second outlet 404 has a constant radius relative to the fourth central axis 408. The fourth central axis 408 is perpendicular to a plane defined by the second outlet 404. According to various embodiments, the third and fourth central axes 406, 408 are not parallel. In some embodiments, the third and fourth central axes 406, 408 are perpendicular.

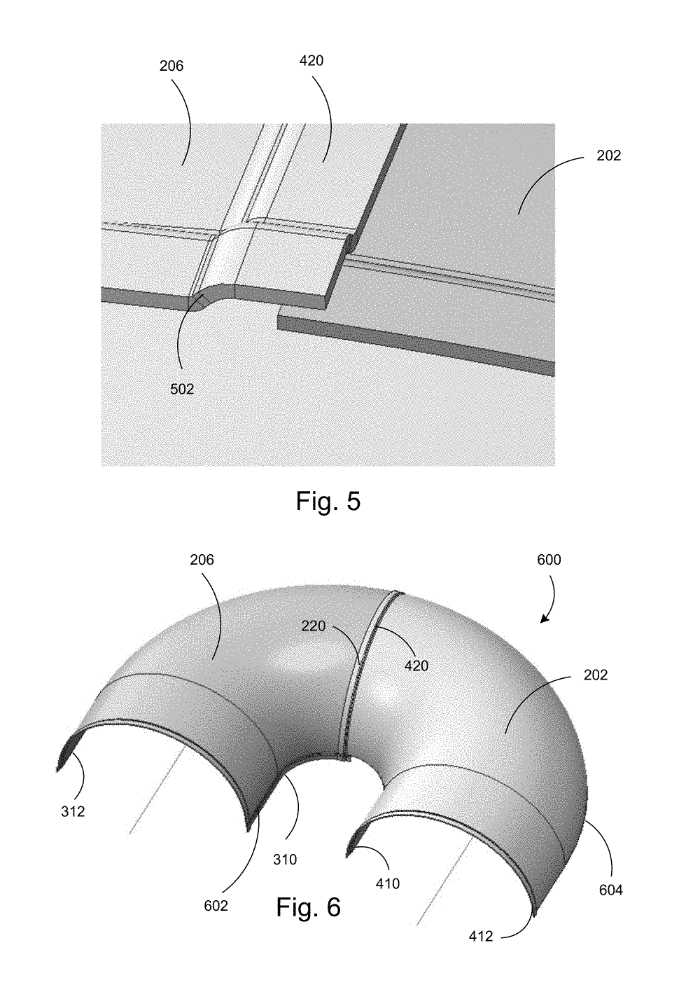

The third half-pipe section 206 has a second inner edge 410 and a second outer edge 412. The second inner edge 410 defines a second inner edge length extending between the second inlet 402 and the second outlet 404. Similarly, the second outer edge 412 defines a second outer edge length extending between the second inlet 402 and the second outlet 404. The third half-pipe section 206 includes a second straight portion 414 and a second curved portion 416. The second curved portion 416 defines a 90 degree bend, which is structured to change a flow direction of exhaust gas flowing therethrough by 90 degrees. Because the first curved portion 316 of the first half-pipe section 202 and the second curved portion 416 of the third half-pipe section 206 each change the flow direction of the exhaust gas flowing therethrough by 90 degrees, the assembled exhaust tube section 200 is structured to change the flow direction of the exhaust gas flowing therethrough by 180 degrees. As illustrated in FIG. 4, the second straight portion 414 defines the second inlet 402 and the second curved portion 416 defines the second outlet 404. The third half-pipe section 206 also includes a lip 420 extending from the second straight portion 414 defining the second outlet 404. The lip 420 is described further below in connection with FIG. 5.

FIG. 5 is a detailed view of the first half-pipe section 202 of FIGS. 2 and 3 being positioned for assembly with the third half-pipe section 206 of FIGS. 2 and 4. In particular, FIG. 5 illustrates the lip 420 of the third half-pipe section 206. The lip 420 includes a bend 502 that offsets the lip 420 from the rest of the third half-pipe section 206. The lip 420 is structured to overlap an outer surface of the first half-pipe section 202 proximate the first outlet 304 upon assembly of the first and third half-pipe sections 202, 206. The first and third half-pipe sections 202, 206 are assembled by welding the first and third half-pipe sections 202, 206 at or near the lip 420 to form the first weld seam 220. The overlapping structure of the lip 420 improves the strength of the weld at the first weld seam 220.

FIG. 6 is a perspective view of a first half-pipe subassembly 600 including the first half-pipe section 202 of FIGS. 2, 3, and 5, and the third half-pipe section 206 of FIGS. 2, 4, and 5. In order to assemble the first half-pipe subassembly 600, the first and third half-pipe sections 202, 206 are positioned adjacent each other, with the first outlet 304 of the first half-pipe section 202 abutting the second inlet 402 of the third half-pipe section 206. Put another way, the first curved portion 316 of the first half-pipe section 202 is positioned so as to abut the second curved portion 416 of the third half-pipe section 206. In particular, the first and third half-pipe sections 202, 206 are positioned so that the lip 420 of the third half-pipe section 206 overlaps a portion of the first curved portion 316 of the first half-pipe section 202. More specifically, the lip 420 of the third half-pipe section 206 overlaps an outer convex surface of the first half-pipe section 202. Upon assembly, the first half-pipe subassembly 600 defines a third inner edge 602 comprising the first inner edge 310 of the first half-pipe section 202 and the second inner edge 410 of the third half-pipe section 206. The first half-pipe subassembly 600 also defines a third outer edge 604 comprising the first outer edge 312 of the first half-pipe section 202 and the second outer edge 412 of the third half-pipe section 206. It should be appreciated that a second half-pipe subassembly, which is a copy of the first half-pipe subassembly 600, is also similarly formed.

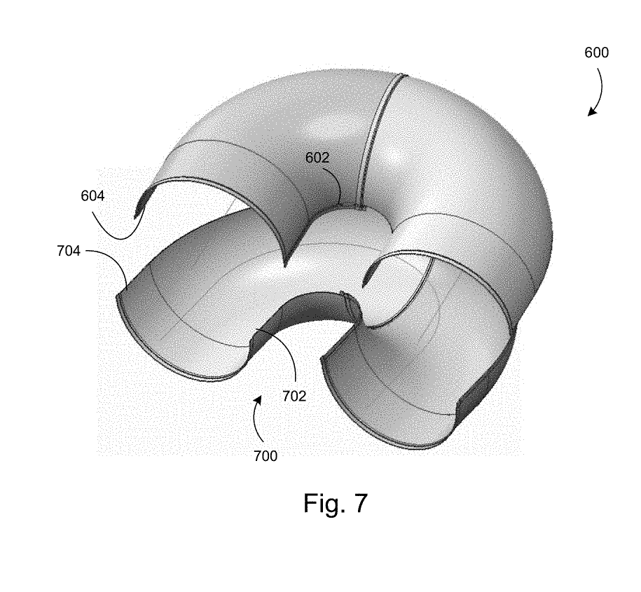

FIG. 7 is an exploded perspective view of the first half-pipe subassembly 600 and a second half-pipe subassembly 700. As shown in FIG. 7, the first half-pipe subassembly 600 is oriented opposite the second half-pipe subassembly 700 such that concave surfaces of each of the first and second half-pipe subassemblies 600, 700 are facing each other. The first half-pipe subassembly 600 is positioned so that the third inner edge 602 of the first half-pipe subassembly 600 abuts a fourth inner edge 702 of the second half-pipe subassembly 700, and so that the third outer edge 604 of the first half-pipe subassembly 600 abuts a fourth outer edge 704 of the second half-pipe subassembly 700. The third and fourth inner edges 602, 702 are welded together, and the third and fourth outer edges 604, 704 are welded together. The exhaust tube section 200, as illustrated in FIG. 2, is formed upon welding the first and second half-pipe subassemblies 600, 700.

It should be understood that angle values described herein are intended to include the nominal stated value ±5 percent. For example, a 180 degree bend or angle may include a bend or angle between about 171 degrees and 189 degrees. Similarly, a 90 degree bend may or angle may include a bend or angle between about 85.5 degrees and 94.5 degrees.

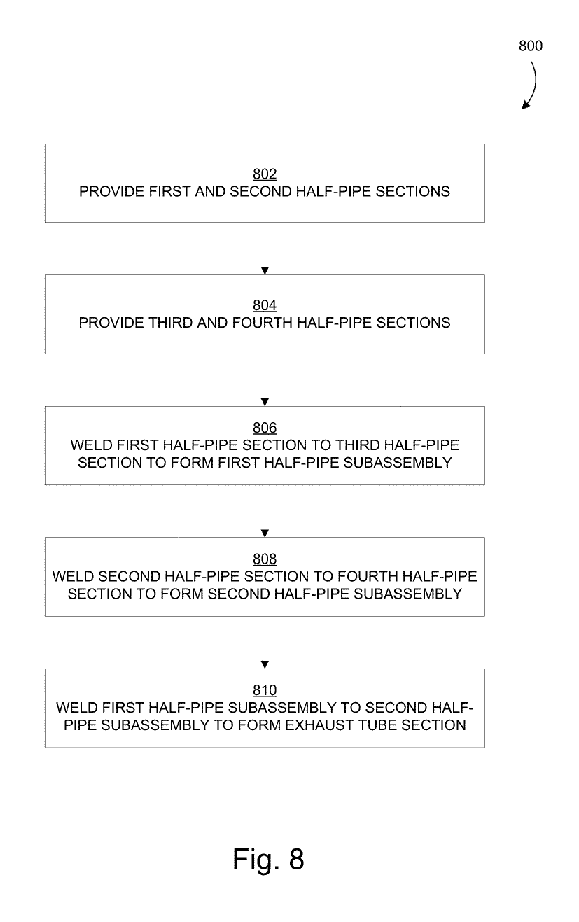

FIG. 8 is a flow chart illustrating a method 800 of manufacturing an exhaust tube section, according to an embodiment. For example, the method 800 can be used to manufacture the bend portion 120 of the exhaust assembly 100 of FIG. 1, or the exhaust tube section 200 of FIG. 2. The method 800 is described below with regard to the exhaust tube section 200 of FIG. 2, including the various components of the exhaust tube section 200 illustrated in FIGS. 3-7. However, it should be understood that the method 800 may similarly be used to manufacture other sheet metal tubing parts.

At 802, first and second half-pipe sections 202, 204 are provided. Each of the first and second half-pipe sections 202, 204 includes a first curved portion and defines a first outer edge length. For example, the first half-pipe section 202 includes the first curved portion 316 and defines the first outer edge length 210. The second half-pipe section 204 also similarly includes a corresponding curved portion and outer edge length. In some embodiments, the first curved portion 316 defines a first bend of about 90 degrees.

At 804, third and fourth half-pipe sections 206, 208 are provided. Each of the third and fourth half-pipe sections 206, 208 includes a second curved portion and defines a second outer edge length. For example, the third half-pipe section 206 includes the second curved portion 416 and defines the second outer edge length 212. The fourth half-pipe section 208 also similarly includes a corresponding curved portion and outer edge length. The second outer edge length 212 of the third and fourth half-pipe sections 206, 208 is longer than the first outer edge length 210 of the first and second half-pipe sections 202, 204. In some embodiments, the second curved portion 416 defines a second bend of about 90 degrees.

At 806, the first half-pipe section 202 is welded to the third half-pipe section 206 so as to form the first half-pipe subassembly 600. The first weld seam 220 is formed upon welding the first and third half-pipe sections 202, 206.

At 808, the second half-pipe section 204 is welded to the fourth half-pipe section 208 so as to form the second half-pipe subassembly 700. The second weld seam 224 is formed upon welding the second and fourth half-pipe sections 204, 208.

At 810, the first half-pipe subassembly 700 is welded to the second half-pipe subassembly 800 so as to form the exhaust tube section 200. The first and second weld seams 220, 224 are not aligned in the completed exhaust tube section 200. Instead, the first and second weld seams 220, 224 are offset because the first and second outer edge lengths 210, 212 are different. In some embodiments, the exhaust tube section 200 is structured to change a flow direction of exhaust gas flowing therethrough by about 180 degrees.

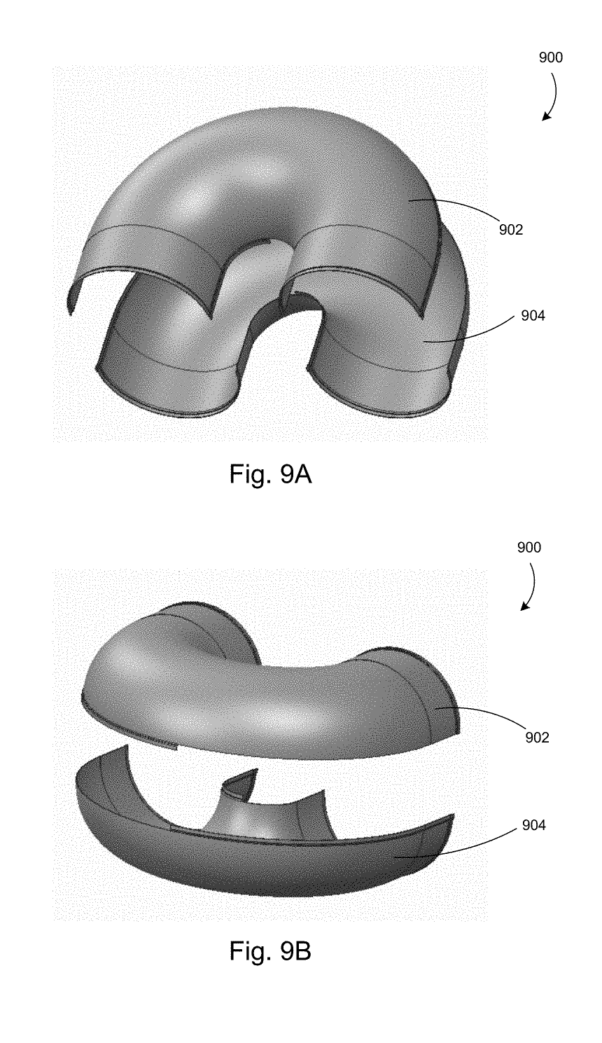

FIGS. 9A and 9B are exploded perspective views of a pipe section 900 including two one-piece half-pipes, according to an alternative embodiment. As shown in FIG. 9, the pipe section 900 includes a first half-pipe 902 and a second half-pipe 904. The first and second half-pipes 902, 904 are each formed from a single piece. In contrast, the first and second half-pipe subassemblies 600, 700 of FIGS. 6 and 7 are each formed from multiple (e.g., two) pieces (e.g., the first and third half-pipe sections 202, 206, and the second and fourth half-pipe sections 204, 208, respectively). The first and second half-pipes 902 are welded together in a manner similar to that described above in connection with welding the first and second half-pipe subassemblies 600, 700 to form the pipe section 900.

In some embodiments, each of the first and second half-pipes 902, 904, and the first, second, third, and fourth half-pipe sections 202, 204, 206, 208 are formed from stamped sheet metal. One side-effect of stamping or otherwise plastically deforming sheet metal is that certain areas of a part (e.g., those areas deformed significantly) may exhibit wall thickness distortion and stress concentrations. In general, for a given part formed from sheet metal having a given raw material thickness, the larger the part, the greater the wall thickness distortion and stress concentrations.

In some embodiments, the one-piece first and second half-pipes 902, 904 are utilized for exhaust tubes having a diameter that is less than a threshold diameter. In contrast, the first and second half-pipe subassemblies 600, 700 formed from multiple pieces are utilized for exhaust tubes having a diameter that is the threshold diameter or greater. For example, in one embodiment, the threshold diameter is five inches. Accordingly, the first and second half-pipes 902, 904, each having been formed from a single piece, are utilized for exhaust tubes having a diameter that is less than five inches. The first and second half-pipe subassemblies 600, 700, each having been formed from multiple (e.g., two) pieces, are utilized for exhaust tubes having a diameter that is five inches or greater.

One benefit to utilizing the one-piece first and second half-pipes 902, 904 is that the first and second weld seams 220, 224 are eliminated. Accordingly, the first and second half-pipes 902, 904 may be identical parts. In contrast, different shaped parts were utilized for the half-pipe sections of the half-pipe subassemblies 600, 700 so that the first and second weld seams 220, 224 are offset.

It should be understood that no claim element herein is to be construed under the provisions of 35 U.S.C. § 112(f), unless the element is expressly recited using the phrase “means for.” The schematic flow chart diagrams and method schematic diagrams described above are generally set forth as logical flow chart diagrams. As such, the depicted order and labeled steps are indicative of representative embodiments. Other steps, orderings and methods may be conceived that are equivalent in function, logic, or effect to one or more steps, or portions thereof, of the methods illustrated in the schematic diagrams. Further, reference throughout this specification to “one embodiment,” “an embodiment,” “an example embodiment,” or similar language means that a particular feature, structure, or characteristic described in connection with the embodiment is included in at least one embodiment of the present invention. Thus, appearances of the phrases “in one embodiment,” “in an embodiment,” “in an example embodiment,” and similar language throughout this specification may, but do not necessarily, all refer to the same embodiment.

Additionally, the format and symbols employed are provided to explain the logical steps of the schematic diagrams and are understood not to limit the scope of the methods illustrated by the diagrams. Although various arrow types and line types may be employed in the schematic diagrams, they are understood not to limit the scope of the corresponding methods. Indeed, some arrows or other connectors may be used to indicate only the logical flow of a method. For instance, an arrow may indicate a waiting or monitoring period of unspecified duration between enumerated steps of a depicted method. Additionally, the order in which a particular method occurs may or may not strictly adhere to the order of the corresponding steps shown. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

Accordingly, the present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. A method comprising:
providing first and second half-pipe sections, each of the first and second half-pipe sections comprising a first curved portion and defining a first outer edge length;
providing third and fourth half-pipe sections, each of the third and fourth half-pipe sections comprising a second curved portion and defining a second outer edge length, the second outer edge length being longer than the first outer edge length;
welding the first half-pipe section to the third half-pipe section so as to form a first half-pipe subassembly;
welding the second half-pipe section to the fourth half-pipe section so as to form a second half-pipe subassembly; and
welding the first half-pipe subassembly to the second half-pipe subassembly so as to form an exhaust tube section.

2. The method of claim 1,
wherein the first half-pipe subassembly comprises a first weld seam and the second half-pipe assembly comprises a second weld seam, and
wherein the first and second weld seams are not aligned in the exhaust tube section.

3. The method of claim 1, wherein the first curved portion defines a 90 degree bend, and wherein the second curved portion defines a 90 degree bend.

4. The method of claim 1, wherein the exhaust tube section is structured to change a flow direction of exhaust gas flowing therethrough by about 180 degrees.

5. The method of claim 1, comprising:
wherein the first half-pipe section comprises a first inlet end defining a first central axis and a first outlet end defining a second central axis, wherein the first and second central axes are not parallel, and
wherein the second half-pipe section comprises a second inlet end defining a third central axis and a second outlet end defining a fourth central axis, wherein the third and fourth central axes are not parallel.

6. The method of claim 5,
wherein the first and second central axes are perpendicular, and
wherein the third and fourth central axes are perpendicular.

7. The method of claim 1,
wherein the first half-pipe subassembly defines a third outer edge length; and
wherein the second half-pipe subassembly defines a fourth outer edge length equal to the third outer edge length.

8. An exhaust tube section comprising:
a first half-pipe section;
a second half-pipe section;
a third half-pipe section; and
a fourth half-pipe section;
wherein the first and third half-pipe sections are welded to one another, forming a first half-pipe subassembly;
wherein the second and fourth half-pipe sections are welded to one another, forming a second half-pipe subassembly;
wherein each of the first and second half-pipe sections comprises a first curved portion and has a first outer edge length;
wherein each of the third and fourth half-pipe sections comprises a second curved portion and has a second outer edge length, the second outer edge length being greater than the first outer edge length.

9. The exhaust tube section of claim 8,
wherein the first half-pipe subassembly comprises a first weld seam and the second half-pipe assembly comprises a second weld seam, and
wherein the first and second weld seams are not aligned in the exhaust tube section.

10. The exhaust tube section of claim 8, wherein the first curved portion defines a 90 degree bend, and wherein the second curved portion defines a 90 degree bend.

11. The exhaust tube section of claim 8, wherein the exhaust tube section is structured to change a flow direction of exhaust gas flowing therethrough by about 180 degrees.

12. The exhaust tube section of claim 8, comprising:
wherein the first half-pipe section comprises a first inlet end defining a first central axis and a first outlet end defining a second central axis, wherein the first and second central axes are not parallel, and
wherein the second half-pipe section comprises a second inlet end defining a third central axis and a second outlet end defining a fourth central axis, wherein the third and fourth central axes are not parallel.

13. The exhaust tube section of claim 12,
wherein the first and second central axes are perpendicular, and
wherein the third and fourth central axes are perpendicular.

14. The exhaust tube section of claim 8,
wherein the first half-pipe subassembly defines a third outer edge length; and
wherein the second half-pipe subassembly defines a fourth outer edge length equal to the third outer edge length.

15. A system, comprising:
an exhaust assembly, comprising:
a first straight portion structured to be fluidly coupled to an engine;
a second straight portion structured to be fluidly coupled to an exhaust aftertreatment component; and
a bend portion fluidly coupled to each of the first and second straight portions, the bend portion comprising:
a first half-pipe section;
a second half-pipe section;
a third half-pipe section;
a fourth half-pipe section;
a first half-pipe subassembly, comprising the first and third half-pipe sections welded to one another; and
a second half-pipe subassembly welded to the first half-pipe subassembly, the second half-pipe subassembly comprising the second and fourth half-pipe sections welded to one another,
wherein each of the first and second half-pipe sections comprises a first curved portion and has a first outer edge length, and
wherein each of the third and fourth half-pipe sections comprises a second curved portion and has a second outer edge length, the second outer edge length being longer than the first outer edge length.

16. The system of claim 15,
wherein the first half-pipe subassembly comprises a first weld seam and the second half-pipe assembly comprises a second weld seam, and
wherein the first and second weld seams are not aligned in the exhaust tube section.

17. The system of claim 15, further comprising:
the engine fluidly coupled to the first straight portion of the exhaust assembly; and
the exhaust aftertreatment component fluidly coupled to the second straight portion of the exhaust assembly,
wherein the exhaust aftertreatment component is in exhaust gas receiving communication with the engine, and in exhaust gas providing communication with the exhaust aftertreatment component.

18. The system of claim 17, wherein the exhaust aftertreatment component is a decomposition reactor.

19. The system of claim 15, wherein the first curved portion defines a 90 degree bend, and wherein the second curved portion defines a 90 degree bend.

20. The system of claim 15, wherein the exhaust assembly is structured to change a flow direction of exhaust gas flowing therethrough by about 180 degrees.

21. The system of claim 15, comprising:
wherein the first half-pipe section comprises a first inlet end defining a first central axis and a first outlet end defining a second central axis, wherein the first and second central axes are not parallel, and
wherein the second half-pipe section comprises a second inlet end defining a third central axis and a second outlet end defining a fourth central axis, wherein the third and fourth central axes are not parallel.

22. The system of claim 21,
wherein the first and second central axes are perpendicular, and
wherein the third and fourth central axes are perpendicular.

23. The system of claim 15,
wherein the first half-pipe subassembly defines a third outer edge length; and
wherein the second half-pipe subassembly defines a fourth outer edge length equal to the third outer edge length.
